(19) United States
(12) Patent Application Publication
(10) Pub. No.: US 2022/0290643 A1
(43) Pub. Date: Sep. 15, 2022

(54) DAMPING INSULATOR FOR FUEL INJECTION DEVICE

(71) Applicant: TOYOTA JIDOSHA KABUSHIKI KAISHA, Toyota-shi (JP)

(72) Inventors: Kazuyoshi MANABE, Toyota-shi (JP); Motonari YARINO, Susono-shi (JP); Koki MIYASHIRO, Toyota-shi (JP)

(21) Appl. No.: 17/654,306

(22) Filed: Mar. 10, 2022

(30) Foreign Application Priority Data
Mar. 12, 2021 (JP) 2021-039880

(51) Int. Cl. F02M 55/04; F02M 61/14

(52) U.S. Cl. CPC F02M 55/04; F02M 61/14

(57) ABSTRACT

A damping insulator restrains vibration to be transmitted between a fuel injection valve and a cylinder head. The fuel injection valve is attached to an insertion hole of the cylinder head. The fuel injection valve includes a stepped portion reduced in diameter in a tapered shape such that an outer-peripheral-side tapered surface is formed to face a shoulder provided in an inlet portion of the insertion hole. The damping insulator restrains the vibration by being provided between the stepped portion and the shoulder. The damping insulator includes an annular tolerance ring having a bottom surface facing the shoulder and an inner-peripheral-side tapered surface facing the outer-peripheral-side tapered surface, and a damping resin layer provided on the bottom surface or the inner-peripheral-side tapered surface of the tolerance ring. The damping resin layer contains heat-resistant resin and damping filler configured to convert vibrational energy into thermal energy.

### CROSS-REFERENCE TO RELATED APPLICATION

This application claims priority to Japanese Patent Application No. 2021-039880 filed on Mar. 12, 2021, incorporated herein by reference in its entirety.

### BACKGROUND

### 1. Technical Field

The present disclosure relates to a damping insulator for a fuel injection device, the damping insulator being for restraining vibration to be transmitted between a cylinder head and a fuel injection valve configured to inject fuel into an internal combustion engine.

### 2. Description of Related Art

In the related art, a cylinder head of an internal combustion engine of a type in which fuel is injected into a combustion chamber, that is, a so-called in-cylinder injection internal combustion engine is configured, for example, such that a distal end side part of a fuel injection valve provided in a fuel injection device is inserted into an insertion hole in the cylinder head in a supported manner, and a base end side part of the fuel injection valve is inserted into a delivery pipe (a fuel injection valve cup) in a supported manner, so that the fuel injection valve is provided over between the cylinder head and the delivery pipe. Generally, such a fuel injection valve is provided with a mechanism configured to open and close a valve needle so as to control injection of fuel. Vibration might be caused at the time of sitting of the valve needle, and the vibration might be transmitted to the cylinder head. Further, in a case where vibration caused on a combustion chamber side is transmitted to the fuel injection valve via the cylinder head, the opening and closing of the fuel injection valve might not be controlled accurately. In view of this, in order to solve such a problem, a damping insulator configured to absorb and restrain such vibration may be attached between the fuel injection valve and the insertion hole in the cylinder head.

As such a damping insulator, for example, WO 2011/121728 describes a damping insulator for a fuel injection valve, the damping insulator being configured to restrain the vibration as described above (see FIG. 2 and so on of WO 2011/121728). The damping insulator includes an annular damping member, an annular plate formed to have a channel-shaped section such that the annular plate wraps a lower part (the lower side in FIG. 2) and an inner peripheral part (the left side in FIG. 2) of the damping member, and an annular tolerance ring provided in an upper part (the upper side in FIG. 2) of the damping member. In the damping insulator, the damping member includes an elastic member such as rubber that is a member for absorbing and restraining vibration of the fuel injection valve, a coil spring embedded in the elastic member in an annular shape, and a sleeve placed on the outer peripheral side from the coil spring and also embedded in the elastic member in an annular shape.

### SUMMARY

In the damping insulator described in WO 2011/121728, the annular tolerance ring supports the fuel injection valve with respect to a cylinder head by abutting with an outer-peripheral-side tapered surface of the fuel injection valve, and the annular tolerance ring is made of metal such as stainless steel. Further, a plate inner end part of the plate is bent to the outer peripheral side such that the plate inner end part abuts with a connecting portion as a connection inclined surface extending diagonally toward the outer peripheral side from a bottom surface of the tolerance ring. The plate is made of metal such as stainless steel, and a lower face of a plate bottom portion abuts with a shoulder of an insertion hole of the cylinder head.

The structure of such a conventional damping insulator includes a path constituted by only a member that easily transmits vibration, e.g., a metal member such as the tolerance ring or the plate, as a path through which vibration is transmitted between the fuel injection valve and the cylinder head. Accordingly, operation vibration of a fuel injection device, e.g., vibration to be caused when a needle inside the fuel injection device advances or retracts to open or close the fuel injection valve, might be transmitted to the cylinder head from the fuel injection valve via the path constituted by only the member such as the metal member that easily transmits vibration and might be emitted to outside as noise.

In the meantime, as vehicles such as an automobile are motorized, a required level to noise and vibration (NV) performance increases more than before. Accordingly, measures to the noise described above are demanded.

The present disclosure is accomplished in view of such points, and an object of the present disclosure is to provide a damping insulator for a fuel injection device that can restrain noise caused by operation vibration of a fuel injection device.

In order to solve the problem, a damping insulator for a fuel injection device according to the present disclosure is a damping insulator for a fuel injection device, the damping insulator being for restraining vibration to be transmitted between a fuel injection valve and a cylinder head. The fuel injection valve is attached to the cylinder head in a state where the fuel injection valve is passed through an insertion hole provided in the cylinder head. A shoulder is provided by expanding an inlet portion of the insertion hole in an annular shape. The fuel injection valve includes a stepped portion reduced in diameter in a tapered shape such that an outer-peripheral-side tapered surface is formed to face the shoulder. The damping insulator is configured to restrain the vibration by being provided between the stepped portion and the shoulder. The damping insulator includes an annular tolerance ring having a bottom surface facing the shoulder and an inner-peripheral-side tapered surface facing the outer-peripheral-side tapered surface, and a damping resin layer provided on the bottom surface or the inner-peripheral-side tapered surface of the tolerance ring. The damping resin layer contains heat-resistant resin and damping filler configured to convert vibrational energy into thermal energy.

With the damping insulator of the present disclosure, it is possible to restrain noise generated by operation vibration of the fuel injection valve.

In the damping insulator, the damping resin layer may be provided on the bottom surface of the tolerance ring.

In the damping insulator, the damping resin layer may have a thickness of 10 μm or more.

With the present disclosure, it is possible to restrain noise generated by operation vibration of the fuel injection valve.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically illustrating a fuel injection device to which a damping insulator for a fuel injection device according to a first embodiment is applied;

FIG. 2A is an enlarged view of a part X illustrated in FIG. 1 and is a sectional view schematically illustrating the damping insulator according to the first embodiment;

FIG. 2B is a sectional view schematically illustrating a damping insulator for a fuel injection device according to a second embodiment and corresponds to FIG. 2A;

FIG. 2C is a sectional view schematically illustrating a damping insulator for a fuel injection device according to a third embodiment and corresponds to FIG. 2A;

FIG. 3 is a sectional view schematically illustrating a falling ball testing machine;

FIG. 4 is a graph illustrating the sound pressure level of sound caused at the time of hitting of a steel ball in relation to the thickness of a damping resin layer in each of test pieces in Examples 1 to 11 and Comparative Example 1; and

FIG. 5 is a graph illustrating acceleration levels of vibration to be transmitted to a cylinder head in three types of mounted damping insulators having different damping-resin-layer formation parts obtained in each of Examples 7, 9, 11.

### DETAILED DESCRIPTION OF EMBODIMENTS

The following describes embodiments according to a damping insulator for a fuel injection device according to the present disclosure. Note that, in the following description, the “damping insulator for a fuel injection device” may be referred to as the “damping insulator.”

### First Embodiment

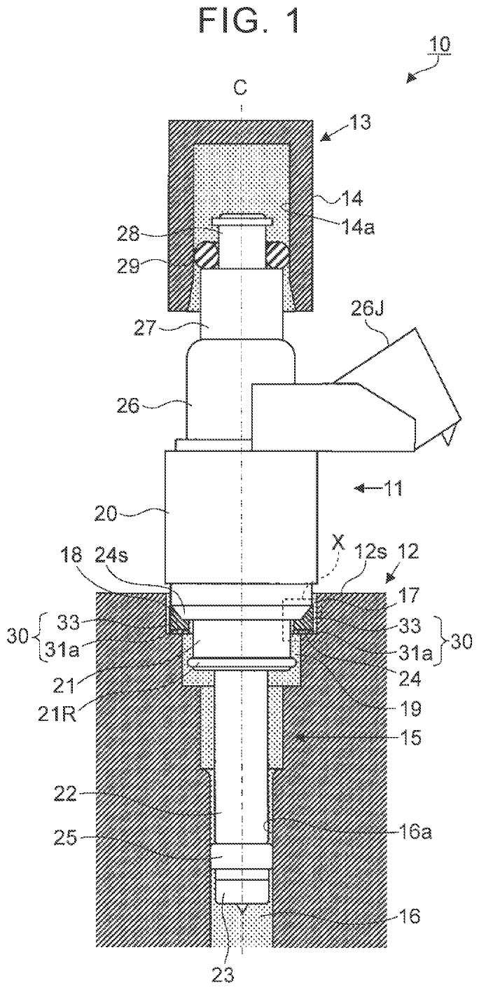

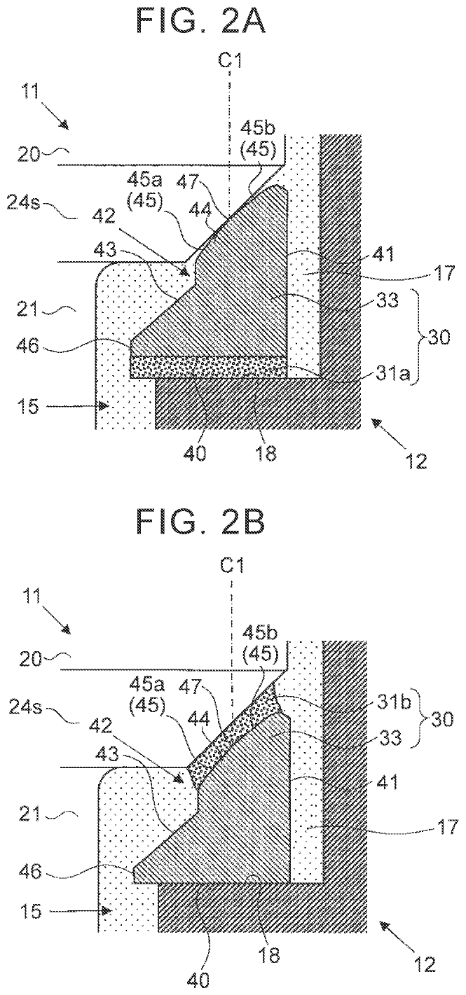

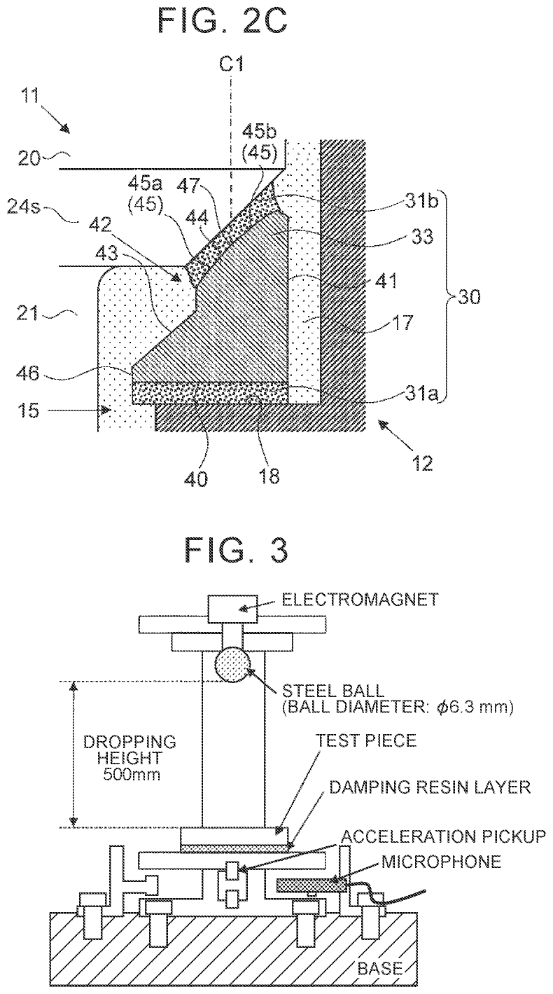

First described is a damping insulator for a fuel injection device according to a first embodiment. FIG. 1 is a sectional view schematically illustrating a fuel injection device to which the damping insulator according to the first embodiment is applied. FIG. 2A is an enlarged view of a part X illustrated in FIG. 1 and is a sectional view schematically illustrating the damping insulator according to the first embodiment.

As illustrated in FIG. 1, a fuel injection device 10 is provided with a fuel injection valve 11. A distal end side part of the fuel injection valve 11 is supported by an insertion hole 15 of a cylinder head 12, and a base end side part of the fuel injection valve 11 is supported by a fuel injection valve cup 14 of a delivery pipe 13, so that the fuel injection valve 11 is provided over between the cylinder head 12 and the delivery pipe 13.

The insertion hole 15 of the cylinder head 12 is provided to penetrate from an outer surface 12s of the cylinder head 12 to an inner surface (not illustrated) thereof as a multistage hole the hole diameter of which gradually narrows as it goes from the outer surface 12s of the cylinder head 12 toward the inner surface thereof. That is, the hole diameter is largest in an inlet portion 17 that is an inlet part from the outer surface 12s of the cylinder head 12, and the hole diameter is smallest in a distal end hole portion 16 opened to the inner surface. Therefore, parts at which the hole diameter of the insertion hole 15 is changed are provided with stepped portions based on differences in the hole diameter. Here, among those stepped portions, a stepped portion between the inlet portion 17 and a hole diameter portion 19 placed under the inlet portion 17 is particularly referred to as a shoulder 18. The shoulder 18 is provided such that the inlet portion 17 of the insertion hole 15 is expanded in an annular shape. The distal end hole portion 16 of the insertion hole 15 communicates with a combustion chamber of an in-cylinder injection internal combustion engine. The fuel injection valve 11 is attached to the cylinder head 12 in a state where the fuel injection valve 11 is passed through the insertion hole 15, and a jet nozzle 23 of the fuel injection valve 11 is attached to the distal end hole portion 16 of the insertion hole 15. The distal end hole portion 16 introduces high-pressure fuel injected from the jet nozzle 23 into the combustion chamber.

The delivery pipe 13 supplies high-pressure fuel accumulated in the delivery pipe 13 at an injection pressure to the fuel injection valve 11, and the delivery pipe 13 includes the fuel injection valve cup 14 to which a base end part of the fuel injection valve 11 is attached in an inserted manner. The sealing property between the fuel injection valve 11 and an inner peripheral surface 14a of the fuel injection valve cup 14 is secured by an O-ring 29 placed therebetween.

The fuel injection valve 11 injects the high-pressure fuel supplied from the delivery pipe 13 into the combustion chamber communicating with the cylinder head 12 in a predetermined timing. A housing of the fuel injection valve 11 has a multistage cylindrical shape and gradually narrows from its center toward the base end side. More specifically, the housing of the fuel injection valve 11 includes a large-diameter portion 20 in the center of the housing, and the housing of the fuel injection valve 11 also includes, sequentially from the large-diameter portion 20 toward its base end, a base-end relay portion 26 having a diameter smaller than that of the large-diameter portion 20, a base-end insertion portion 27 having a diameter smaller than that of the base-end relay portion 26, and a base-end sealed portion 28 having a diameter smaller than that of the base-end insertion portion 27. The base-end relay portion 26 is provided with a connector 26J to which a wiring line is connected. The wiring line is used to transmit a driving signal to an electromagnetic valve or the like provided in the fuel injection valve 11. The base-end sealed portion 28 is inserted into the O-ring 29.

The O-ring 29 is made of an elastic member such as rubber having durability to fuel such that the O-ring 29 is formed in a generally toric shape, and the O-ring 29 has proof pressure against the pressure of the high-pressure fuel. The inner periphery of the O-ring 29 makes close contact with an outer peripheral surface of the base-end sealed portion 28. The close contact between the inner periphery of the O-ring 29 and the outer peripheral surface of the base-end sealed portion 28 achieves a sealing property that prevents leakage of the high-pressure fuel between the fuel injection valve 11 and the O-ring 29. The outer periphery of the O-ring 29 is formed to have a magnitude that allows the O-ring 29 to make close contact with the inner peripheral surface 14a of the fuel injection valve cup 14 of the delivery pipe 13. That is, when the base end part of the fuel injection valve 11 is inserted into the fuel injection valve cup 14 of the delivery pipe 13, the outer periphery of the O-ring 29 makes close contact with the inner peripheral surface 14a of the fuel injection valve cup 14, so that the sealing property against the high-pressure fuel is achieved. When the O-ring 29 achieves the sealing property for the outer peripheral surface of the base-end sealed portion 28 and the inner peripheral surface 14a of the fuel injection valve cup 14, the sealing property against the high-pressure fuel is secured between the fuel injection valve 11 and the fuel injection valve cup 14.

Note that the sealing property against the high-pressure fuel that is secured between the fuel injection valve 11 and the fuel injection valve cup 14 by the O-ring 29 is maintained to be high in a case where the distance between the outer peripheral surface of the base-end sealed portion 28 and the inner peripheral surface 14a of the fuel injection valve cup 14 is uniform over the whole circumference, e.g., in a case where an axial center C of the fuel injection valve 11 coincides with the axial center of the fuel injection valve cup 14. That is, the thickness of the O-ring 29 is uniform over the whole circumference between the outer peripheral surface of the base-end sealed portion 28 and the inner peripheral surface 14a of the fuel injection valve cup 14, so that a uniform sealing property is secured. In the meantime, in a case where the distance between the outer peripheral surface of the base-end sealed portion 28 and the inner peripheral surface 14a of the fuel injection valve cup 14 is not uniform over the whole circumference, the thickness of the O-ring 29 is not uniform over the whole circumference. That is, in a part of the O-ring 29 that is thinned by being pressed strongly, a large reaction force occurs, so that a high adhesion strength is achieved. In the meantime, in a part of the O-ring 29 that is not pressed strongly, the reaction force is small, so that the adhesion property decreases. In a case where the position of the axial center C of the fuel injection valve 11 deviates from the position of the axial center of the fuel injection valve cup 14 around the center of the O-ring 29 as such, the sealing property between the fuel injection valve 11 and the fuel injection valve cup 14 might decrease to cause leakage of the high-pressure fuel.

The housing of the fuel injection valve 11 gradually narrows from the center toward the distal end side, and the housing of the fuel injection valve 11 includes, sequentially from the large-diameter portion 20 toward its distal end, a middle-diameter portion 21 having a diameter smaller than that of the large-diameter portion 20, and a small-diameter portion 22 having a diameter smaller than that of the middle-diameter portion 21. The jet nozzle 23 configured to inject fuel is provided in a distal end of the small-diameter portion 22. A sealed portion 25 is provided on the base end side from the jet nozzle 23 in the small-diameter portion 22 such that the sealed portion 25 secures a sealing property between the small-diameter portion 22 and an inner peripheral surface 16a of the distal end hole portion 16 so as to maintain airtightness of the combustion chamber communicating with the insertion hole 15.

A stepped portion 24 is provided between the large-diameter portion 20 and the middle-diameter portion 21 of the housing of the fuel injection valve 11 based on the difference between the outside diameter of the large-diameter portion 20 and the outside diameter of the middle-diameter portion 21. The stepped portion 24 has a shape reduced in diameter in a tapered shape toward the distal end side of the fuel injection valve 11 such that the stepped portion 24 has an outer-peripheral-side tapered surface 24s. The outer-peripheral-side tapered surface 24s has a shape narrowing toward the distal end side of the fuel injection valve 11. The outer-peripheral-side tapered surface 24s of the stepped portion 24 of the fuel injection valve 11 faces the annular shoulder 18 placed in the inlet portion 17 of the insertion hole 15 of the cylinder head 12.

As illustrated in FIGS. 1, 2A, the damping insulator 30 according to Embodiment 1 is an annular damping insulator configured to restrain vibration to be transmitted between a fuel injection valve and a cylinder head and is configured to restrain the vibration by being provided between the stepped portion 24 and the shoulder 18.

The outside diameter of the damping insulator 30 is set to a magnitude that allows the damping insulator 30 to be placed on the annular shoulder 18. The inside diameter of the damping insulator 30 is set to a magnitude that allows the middle-diameter portion 21 of the fuel injection valve 11 to be passed through inside the damping insulator 30 with an allowance being provided between the middle-diameter portion 21 and the damping insulator 30. Further, a ring 21R having an outer periphery larger than the inner periphery of the damping insulator 30 is provided on the distal end side of the middle-diameter portion 21 of the fuel injection valve 11. The ring 21R prevents the damping insulator 30 through which the middle-diameter portion 21 is passed from being uncoupled from the middle-diameter portion 21.

The damping insulator 30 includes an annular tolerance ring 33. The tolerance ring 33 is made of stainless steel. Further, as illustrated in FIG. 2A, the tolerance ring 33 has a section having a right-angled triangular shape and includes a bottom surface 40, an inner peripheral surface 46, an outer peripheral surface 41, and an inner peripheral inclined surface 42 extending diagonally upward from an upper end of the inner peripheral surface 46 to an upper end of the outer peripheral surface 41. The bottom surface 40 faces the annular shoulder 18 of the inlet portion 17 of the insertion hole 15. The inner peripheral inclined surface 42 is an inner peripheral side surface constituting a reassessed shape around the center of the annular shape of the tolerance ring 33 and constitutes a tapered shape of the section of the tolerance ring 33 illustrated in FIG. 2A.

The inner peripheral inclined surface 42 includes a connecting portion 43 as a connection inclined surface extending diagonally upward from the upper end of the inner peripheral surface 46 toward the outer peripheral side, and an inner-peripheral-side tapered surface 45 placed one step higher than the connecting portion 43 and extending diagonally upward further toward the outer peripheral side. An inner peripheral edge of the connecting portion 43 is continuous with an inner peripheral edge of the bottom surface 40 via the inner peripheral surface 46. The inner-peripheral-side tapered surface 45 has a shape expanding toward the base end side of the fuel injection valve 11 such that the inner-peripheral-side tapered surface 45 faces the outer-peripheral-side tapered surface 24s of the fuel injection valve 11.

The inner-peripheral-side tapered surface 45 includes an inner tapered surface 45a placed one step higher than the connecting portion 43 and extending diagonally upward toward the outer peripheral side, and an outer tapered surface 45b extending diagonally upward from the inner tapered surface 45a further toward the outer peripheral side at a smaller angle. The inner-peripheral-side tapered surface 45 constitutes an abutment portion 44 facing the outer-peripheral-side tapered surface 24s of the fuel injection valve 11.

In FIG. 2A, an edge line 47 as a border line between the inner tapered surface 45a and the outer tapered surface 45b of the inner-peripheral-side tapered surface 45 is expressed as the vertex of a part projecting from the abutment portion 44 toward the outer-peripheral-side tapered surface 24s. That is, the edge line 47 is placed at a position where the outer peripheral edge of the inner tapered surface 45a abuts with the inner peripheral edge of the outer tapered surface 45b, and the inner tapered surface 45a and the outer tapered surface 45b constitute the two-stage inner-peripheral-side tapered surface 45. Here, in a case where the angle of a tapered surface is taken as an inclination angle from a parallel line Cl that is parallel to the axial center C of the tolerance ring, the angle of the inner tapered surface 45a is set to be smaller than the angle of the outer-peripheral-side tapered surface 24s of the fuel injection valve 11, and the angle of the outer tapered surface 45b is set to be larger than the angle of the outer-peripheral-side tapered surface 24s of the fuel injection valve 11. Accordingly, in FIG. 2A, the edge line 47 is expressed as a vertex that makes point contact with the outer-peripheral-side tapered surface 24s of the fuel injection valve 11. That is, the inner-peripheral-side tapered surface 45 abuts with the outer-peripheral-side tapered surface 24s by line contact at the edge line 47.

As illustrated in FIGS. 1, 2A, the damping insulator 30 further includes a damping resin layer 31a provided on the bottom surface 40 of the tolerance ring 33. Hereby, the damping insulator 30 abuts with the shoulder 18 of the insertion hole 15 of the cylinder head 12 only by the damping resin layer 31a. The damping resin layer 31a contains heat-resistant resin and damping filler configured to convert vibrational energy into thermal energy. In the meantime, the damping insulator 30 abuts with the outer-peripheral-side tapered surface 24s of the fuel injection valve 11 by the inner-peripheral-side tapered surface 45 of the tolerance ring 33. Thus, the fuel injection valve 11 is supported by the cylinder head 12 via the damping insulator 30.

Accordingly, in the structure of the damping insulator 30 according to the first embodiment, the damping resin layer 31a that can effectively block transmission of vibration is present in a path that transmits vibration between the fuel injection valve 11 and the cylinder head 12. Hereby, it is possible to restrain, for example, such a situation that operation vibration of the fuel injection device such as vibration to be caused when a needle advances or retracts to open or close the fuel injection valve is transmitted from the fuel injection valve to the cylinder head and emitted to outside the vehicle or inside a vehicle cabin as noise. Further, it is also possible to restrain such a situation that the operation vibration is transmitted from the fuel injection valve to the cylinder head and causes false detection in a sensor configured to detect abnormal combustion represented by knocking or the like.

Further, the inner-peripheral-side tapered surface 45 of the tolerance ring 33 is constituted by two steps, i.e., the inner tapered surface 45a and the outer tapered surface 45b between which the edge line projecting toward the outer-peripheral-side tapered surface 24s is formed, and the inner-peripheral-side tapered surface 45 abuts with the outer-peripheral-side tapered surface 24s by line contact at the edge line 47. Accordingly, when the axial center C of the fuel injection valve 11 is to incline, the fuel injection valve 11 can slide on the edge line 47 of the inner-peripheral-side tapered surface 45 of the tolerance ring 33. Hereby, it is possible to restrain the reaction force from the damping insulator 30 to the fuel injection valve 11 from acting along with the inclination of the fuel injection valve 11. As a result, it is possible to restrain occurrence of such a problem that the sealing property of the O-ring 29 between the fuel injection valve 11 and the fuel injection valve cup 14 decreases due to the reaction force.

Further, differently from the damping insulators 30 according to second and third embodiments to be described later, the damping insulator 30 according to the first embodiment is configured such that the damping resin layer is provided only on the bottom surface 40 of the tolerance ring 33. Accordingly, in comparison with the second and third embodiments, it is possible to simplify the manufacturing process and reduce the manufacturing cost.

### Second Embodiment

Next will be described a damping insulator according to the second embodiment only in differences from the damping insulator according to the first embodiment. FIG. 2B is a sectional view schematically illustrating the damping insulator according to the second embodiment and corresponds to FIG. 2A.

The damping insulator 30 according to the second embodiment includes a damping resin layer 31b provided on the inner-peripheral-side tapered surface 45 of the tolerance ring 33, instead of the damping resin layer 31a provided on the bottom surface 40 of the tolerance ring 33. Hereby, the damping insulator 30 abuts with the outer-peripheral-side tapered surface 24s of the fuel injection valve 11 only by the damping resin layer 31b. The damping resin layer 31b contains heat-resistant resin and damping filler configured to convert vibrational energy into thermal energy. In the meantime, the damping insulator 30 abuts with the shoulder 18 of the insertion hole 15 of the cylinder head 12 by the bottom surface 40 of the tolerance ring 33. Thus, the fuel injection valve 11 is supported by the cylinder head 12 via the damping insulator 30.

Accordingly, in the structure of the damping insulator 30 according to the second embodiment, the damping resin layer 31b that can effectively block transmission of vibration is present in the path that transmits vibration between the fuel injection valve 11 and the cylinder head 12. Hereby, similarly to the first embodiment, it is possible to restrain the operation vibration of the fuel injection device from being transmitted to the cylinder head from the fuel injection valve and emitted to outside the vehicle or the like as noise. In the meantime, differently from the first embodiment, the inner-peripheral-side tapered surface 45 of the tolerance ring 33 does not abut with the outer-peripheral-side tapered surface 24s of the fuel injection valve 11 by line contact at the edge line 47, and therefore, it is difficult to sufficiently restrain the reaction force from the damping insulator 30 to the fuel injection valve 11 from acting along with the inclination of the fuel injection valve 11.

### Third Embodiment

Next will be described a damping insulator for a fuel injection device according to the third embodiment only in differences from the damping insulator according to the first embodiment. FIG. 2C is a sectional view schematically illustrating the damping insulator according to the third embodiment and corresponds to FIG. 2A.

The damping insulator 30 according to the third embodiment includes the damping resin layer 31b provided on the inner-peripheral-side tapered surface 45 of the tolerance ring 33, in addition to the damping resin layer 31a provided on the bottom surface 40 of the tolerance ring 33. Hereby, the damping insulator 30 abuts with the shoulder 18 of the insertion hole 15 of the cylinder head 12 only by the damping resin layer 31a. The damping resin layer 31a contains heat-resistant resin and damping filler configured to convert vibrational energy into thermal energy. Further, the damping insulator 30 abuts with the outer-peripheral-side tapered surface 24s of the fuel injection valve 11 only by the damping resin layer 31b. The damping resin layer 31b contains heat-resistant resin and damping filler configured to convert vibrational energy into thermal energy. Thus, the fuel injection valve 11 is supported by the cylinder head 12 via the damping insulator 30.

Accordingly, in the structure of the damping insulator 30 according to the third embodiment, the damping resin layer 31a and the damping resin layer 31b that can effectively block transmission of vibration are provided in the path that transmits vibration between the fuel injection valve 11 and the cylinder head 12. Hereby, it is possible to restrain the operation vibration of the fuel injection device from being transmitted to the cylinder head from the fuel injection valve and emitted to outside the vehicle or the like as noise, more effectively than the first embodiment. In the meantime, differently from the first embodiment, the inner-peripheral-side tapered surface 45 of the tolerance ring 33 does not abut with the outer-peripheral-side tapered surface 24s of the fuel injection valve 11 by line contact at the edge line 47, and therefore, it is difficult to sufficiently restrain the reaction force from the damping insulator 30 to the fuel injection valve 11 from acting along with the inclination of the fuel injection valve 11.

The following describes details of the constituents of the damping insulators according to the embodiments.

1. Tolerance Ring

The tolerance ring is an annular-shaped member having a bottom surface facing the shoulder and an inner-peripheral-side tapered surface facing the outer-peripheral-side tapered surface. The material of the tolerance ring is metal, e.g., stainless steel such as SUS304 that is a hard stainless steel material. As the material of the tolerance ring, metal having a hardness equivalent to the outer-peripheral-side tapered surface of the fuel injection valve may be also usable.

2. Damping Resin Layer

The damping resin layer is provided on the bottom surface or the inner-peripheral-side tapered surface of the tolerance ring. The damping resin layer contains heat-resistant resin and damping filler configured to convert vibrational energy into thermal energy.

It is preferable that the damping resin layer be provided on the bottom surface of the tolerance ring. The reason is as follows. That is, as described in the first embodiment, the inner-peripheral-side tapered surface of the tolerance ring can abut with the outer-peripheral-side tapered surface of the fuel injection valve by line contact, and therefore, it is possible to restrain the reaction force from the damping insulator to the fuel injection valve from acting along with the inclination of the fuel injection valve. Further, the manufacturing process can be simplified, and the manufacturing cost can be reduced.

The thickness of the damping resin layer is not limited in particular. However, the thickness of the damping resin layer is preferably 10 μm or more, more preferably 20 μm or more, and particularly preferably 50 μm or more. This is because a vibration-transmission block effect can be sufficiently obtained. The thickness of the damping resin layer is preferably 400 μm or less, more preferably 200 μm or less, and particularly preferably 100 μm or less. This is because the improvement in the vibration block effect is saturated, and layer formation is easily achievable by coating.

The heat-resistant resin is not limited in particular, provided that the heat-resistant resin has a heat distortion temperature of 100° C. or more. However, the heat-resistant resin is preferably resin having a heat distortion temperature of 150° C. or more. Examples of the heat-resistant resin is not limited in particular and can be polyamideimide resin, polyimide resin, phenolic resin, epoxy resin, polyethersulfone resin, polyphenyl sulfide resin, and so on. From the viewpoint of workability at the time of forming a coating film and a heat-resisting property against heat generation, polyamideimide resin is further preferable. One type of heat-resistant resin may be used solely, or two or more types thereof may be used in combination.

The damping filler converts vibrational energy into thermal energy. The damping filler is not limited in particular, but the damping filler can be roughly classified to a material having a low modulus of elasticity and easily deformable and a material in which energy dissipation easily occurs. The material having a low modulus of elasticity and easily deformable is more specifically a material that is solid but conspicuously has both an elastic characteristic and a viscous characteristic. The elastic characteristic and the viscous characteristic are characteristics that all materials have, but the material having a low modulus of elasticity and easily deformable conspicuously has both of the characteristics. Accordingly, when the damping resin layer contains the material having a low modulus of elasticity and easily deformable, the rubber elasticity of the damping resin layer itself in an ordinary temperature range can be increased. Since vibration input from outside is more effectively absorbed and converted into thermal energy by the damping resin layer, it is considered that transmission of the vibration can be blocked effectively. In the meantime, the material in which energy dissipation easily occurs has an effect to attenuate vibration by converting the vibration into thermal energy by diffusely reflecting the vibration by an atmospheric layer present inside the material. Accordingly, when the damping resin layer contains the material in which energy dissipation easily occurs, it is considered that transmission of the vibration can be effectively blocked by the damping resin layer.

Examples of the material having a low modulus of elasticity and easily deformable include thermoplastic elastomer, urethane-based compounds, polyethylene-based compounds, ester copolymer, rubber-based materials, and so on. The thermoplastic elastomer generally has the characteristic of rubber at room temperature and exhibits performance equivalent to thermoplastic at high temperature. Examples of the thermoplastic elastomer include thermoplastic styrenic elastomer, thermoplastic olefinic elastomer, vinyl chloride-based thermoplastic elastomer, urethane-based thermoplastic elastomer, ester-based thermoplastic elastomer, amide-based thermoplastic elastomer, and so on. These examples are described, for example, in Japanese Unexamined Patent Application Publication No. 2016-113614 (JP 2016-113614 A), Japanese Unexamined Patent Application Publication No. 2017-197733 (JP 2017-197733 A), and so on. Examples of the urethane-based compounds include urethane resin and so on. These examples are described, for example, in Japanese Unexamined Patent Application Publication No. 8-183945 (JP 8-183945 A). Examples of the polyethylene-based compounds include homopolymer of ethylene, copolymer of ethylene and α-olefin monomer, and so on. These examples are described, for example, in Japanese Unexamined Patent Application Publication (Translation of PCT Application) No. 2009-532570 (JP 2009-532570 A) and so on. Examples of the ester copolymer include acrylic ester copolymer and so on. These examples are described, for example, in Japanese Patent No. 3209499 (JP 3209499 B) and so on. Examples of the rubber-based material include butyl rubber, fluoro rubber and so on. These examples are described, for example, in Japanese Unexamined Patent Application Publication No. 2009-236172 (JP 2009-236172 A) and so on.

Examples of the material in which energy dissipation easily occurs include a microcapsule-based material, a low-density material, and so on. Examples of the microcapsule-based material include a thermal-expansion microcapsule configured such that vapor that expands within a predetermined temperature range is contained inside a shell made of thermoplastic polymer, and so on. These examples are described in Japanese Unexamined Patent Application Publication No. 2013-18855 (JP 2013-18855 A) and so on. Examples of the low-density material include general materials including an atmospheric layer thereinside, for example, and more specifically, include a foam material, a porous body, a non-woven fabric, a layered compound, and so on, for example. These examples are described, for example, in Japanese Unexamined Patent Application Publication No. 3-221173 (JP 3-221173 A), Japanese Patent No. 4203589 (JP 4203589 B), and so on. Only one type of damping filler may be used solely, or two or more types of damping filler may be used in combination.

The damping resin layer may contain a given component such as solid lubricant or hard particles in addition to the heat-resistant resin and the damping filler. This is because characteristics such as abrasion resistance, seizure resistance, and a low friction characteristic can be given to the damping resin layer. The solid lubricant is not limited in particular, and examples of the solid lubricant include polytetrafluoroethylene (PTFE), molybdenum disulfide (MoS₂), graphite, and so on, for example. One type of solid lubricant may be used solely, or two or more types thereof may be used in combination. The hard particles are not limited in particular, and examples of the hard particles include alumina (Al₂O₃), silica, and so on. One type of hard particles may be used solely, or two or more types thereof may be used in combination.

The volume ratio of the damping filler to the total volume of the heat-resistant resin and the damping filler in the damping resin layer is not limited in particular, but the volume ratio of the damping filler is preferably in a range of 20 vol % or more but 80 vol % or less, and more preferably in a range of 40 vol % or more but 60 vol % or less. The reason is as follows. When the volume ratio of the damping filler is equal to or more than the lower limits of these ranges, it is possible to more effectively convert vibrational energy into thermal energy by the filler. Further, when the volume ratio of the damping filler is equal to or less than the upper limits of these ranges, durability (e.g., abrasion resistance, adhesion, and the like) as resin coating can be secured. Note that the volume ratio of the given component other than the heat-resistant resin and the damping filler in the damping resin layer is not limited in particular and can be selected depending on the type of the given component. Further, the damping resin layer is not limited in particular, provided that the damping resin layer can attenuate vibration at a desired frequency that is to be transmitted between the fuel injection valve and the cylinder head. However, it is preferable that the damping resin layer attenuate vibration at a frequency of 2 kHz, for example. This is because noise caused by operation vibration of the fuel injection valve can be restrained particularly effectively. Note that, in order to adjust the damping resin layer to attenuate vibration at a desired frequency, the type or the contained amount of each component such as the damping filler or the heat-resistant resin in the damping resin layer, the thickness of the damping resin layer, or the like should be adjusted.

A method for forming the damping resin layer is not limited in particular, but the following method and so on can be used, for example. First, a solution is prepared by dissolving a predetermined amount of heat-resistant resin in an organic solvent. Subsequently, a predetermined amount of damping filler is added to the solution, a given component is further added as necessary, and they are kneaded so that an application material is prepared. Subsequently, the application material is applied to a bottom surface or an inner-peripheral-side tapered surface of a tolerance ring. Then, the application material thus applied to the tolerance ring is heated to be dried and hardened. Hereby, the damping resin layer is formed.

The organic solvent to be used in the above method is not limited in particular and is selected depending on the type of the heat-resistant resin. In a case where polyamideimide resin is used as the heat-resistant resin, for example, N-methyl-2-pyrrolidone (NMP), N-ethyl pyrrolidone (NEP), 1,3-dimethyl-2-imidazolidinone (DMI), γ-butyrolactone (GBL), or the like is used as the organic solvent. Further, in a case where epoxy resin is used, methyl ethyl ketone (MEK), toluene, or the like is used.

A method for the kneading to prepare the application material is a method for performing kneading for one hour by use of a kneader, for example. An application method for applying the application material to the tolerance ring is not limited in particular, and a general application method can be used, e.g., spray coating, screen-printing, dipping, and so on. A heating condition to dry and harden the application material is not limited in particular and may be, for example, such a condition that heating is performed at a temperature of 100° C. or more but 370° C. or less for 30 minutes or more but 3 hours or less.

3. Damping Insulator for Fuel Injection Device

The damping insulator is a damping insulator for a fuel injection device that is configured to restrain vibration to be transmitted between a fuel injection valve and a cylinder head. The fuel injection valve is attached to the cylinder head in a state where the fuel injection valve is passed through an insertion hole provided in the cylinder head. A shoulder is provided by expanding an inlet portion of the insertion hole in an annular shape. The fuel injection valve has a stepped portion reduced in diameter in a tapered shape such that an outer-peripheral-side tapered surface is formed to face the shoulder. The damping insulator is configured to restrain the vibration by being provided between the stepped portion and the shoulder and.

An internal combustion engine to which the damping insulator is applied is not limited in particular and may be, for example, an in-cylinder injection internal combustion engine, a gasoline engine, or a diesel engine.

The following further more specifically describes the damping insulators according to the embodiments with reference to Examples and Comparative Examples.

### Example 1

First, an application material to be used for formation of a damping resin layer in a damping insulator was prepared. More specifically, first, polyamideimide resin was prepared as heat-resistant resin, and a predetermined amount of the polyamideimide resin was dissolved in N-ethyl-2-pyrrolidone (NEP) (organic solvent), so that a solution was prepared. Subsequently, thermoplastic elastomer was prepared as damping filler, and a predetermined amount of the thermoplastic elastomer was added to the solution and subjected to kneading by use of a kneader for one hour. Hereby, the application material was prepared such that the volume ratio of the damping filler to the total volume of the heat-resistant resin and the damping filler in the damping resin layer was 50 vol %.

Subsequently, a test piece in which a damping resin layer was formed on the surface of a block-shaped base material was manufactured. More specifically, a block-shaped base material made of SUS440C was prepared first, and a predetermined amount of the application material was applied to the surface of the base material by spray coating. Subsequently, the application material applied to the base material was heated at 180° C. for 90 minutes so that the organic solvent was volatilized, and thus, the application material was dried and hardened. Hereby, a damping resin layer having a thickness of 1 μm was formed on the surface of the base material, and thus, the test piece was manufactured.

### Example 2

A test piece was manufactured in a similar manner to Example 1 except that a damping resin layer was formed to have a thickness of 5 μm.

### Example 3

A test piece was manufactured in a similar manner to Example 1 except that a damping resin layer was formed to have a thickness of 10 μm.

### Example 4

A test piece was manufactured in a similar manner to Example 1 except that a damping resin layer was formed to have a thickness of 20 μm.

### Example 5

A test piece was manufactured in a similar manner to Example 1 except that a damping resin layer was formed to have a thickness of 50 μm.

### Example 6

A test piece was manufactured in a similar manner to Example 1 except that a damping resin layer was formed to have a thickness of 100 μm.

### Example 7

First, a test piece was manufactured in a similar manner to Example 1 except that a damping resin layer was formed to have a thickness of 200 μm.

Subsequently, a damping insulator including the damping resin layer on a bottom surface of a tolerance ring was manufactured and mounted in a fuel injection device, so that a mounted damping insulator was manufactured.

More specifically, first, an annular tolerance ring made of SUS440C was prepared. The tolerance ring has a bottom surface facing a shoulder of an insertion hole of a cylinder head, and an inner-peripheral-side tapered surface facing an outer-peripheral-side tapered surface of a fuel injection valve. Subsequently, a predetermined amount of an application material similar to the application material used in Example 1 was applied to the bottom surface of the tolerance ring by spray coating. Subsequently, the application material applied to the tolerance ring was heated at 180° C. for 90 minutes such that the organic solvent was volatilized, and thus, the application material was dried and hardened. Hereby, a damping resin layer having a thickness of 200 μm was formed on the bottom surface of the tolerance ring, and thus, the damping insulator was manufactured.

Subsequently, a cylinder head, a fuel injection valve, and a delivery pipe were prepared. The cylinder head has an insertion hole, and a shoulder is provided by expanding an inlet portion of the insertion hole in an annular shape. A housing of the fuel injection valve has a multistage cylindrical shape and has a stepped portion reduced in diameter in a tapered shape such that an outer-peripheral-side tapered surface is formed to face the shoulder of the insertion hole of the cylinder head. Subsequently, the damping insulator and the fuel injection valve were attached to the cylinder head, and the delivery pipe was further attached thereto. After that, they were fastened by bolts. At this time, the damping insulator was placed between the shoulder and the stepped portion so that the damping insulator abutted with the shoulder of the insertion hole of the cylinder head only by the damping resin layer, and the inner-peripheral-side tapered surface of the tolerance ring abutted with the outer-peripheral-side tapered surface of the fuel injection valve. Thus, the mounted damping insulator was manufactured.

Subsequently, a damping insulator including the damping resin layer on an inner-peripheral-side tapered surface of a tolerance ring was manufactured and mounted on a fuel injection device, so that a mounted damping insulator was manufactured. More specifically, first, the damping insulator was manufactured in a similar manner to the case where the damping insulator including the damping resin layer on the bottom surface of the tolerance ring was manufactured as described above, except that a damping-resin-layer formation part was set to the inner-peripheral-side tapered surface of the tolerance ring. Subsequently, the damping insulator was mounted in the fuel injection device in a similar manner to the case where the damping insulator including the damping resin layer on the bottom surface of the tolerance ring was mounted in the fuel injection device as described above, except that the damping insulator was placed between the shoulder and the stepped portion such that the damping insulator abutted with the shoulder of the insertion hole of the cylinder head by the bottom surface of the tolerance ring, and the damping insulator abutted with the outer-peripheral-side tapered surface of the fuel injection valve only by the damping resin layer. Thus, the mounted damping insulator was manufactured.

Subsequently, a mounted damping insulator was manufactured such that a damping insulator including the damping resin layer on both a bottom surface and an inner-peripheral-side tapered surface of a tolerance ring was manufactured and mounted in a fuel injection device. More specifically, first, the damping insulator was manufactured in a similar manner to the case where the damping insulator including the damping resin layer on the bottom surface of the tolerance ring was manufactured as described above, except that a damping-resin-layer formation part was set to the bottom surface and the inner-peripheral-side tapered surface of the tolerance ring. Subsequently, the damping insulator was mounted in the fuel injection device in a similar manner to the case where the damping insulator including the damping resin layer on the bottom surface of the tolerance ring was mounted in the fuel injection device as described above, except that the damping insulator was placed between the shoulder and the stepped portion so that the damping insulator abutted with the shoulder of the insertion hole of the cylinder head only by the damping resin layer formed on the bottom surface side, and the damping insulator abutted with the outer-peripheral-side tapered surface of the fuel injection valve only by the damping resin layer formed on the inner peripheral side. Thus, the mounted damping insulator was manufactured.

### Example 8

First, an application material was prepared in a similar manner to Example 1 except that urethane resin was prepared as damping filler, and a predetermined amount of the urethane resin was added to a solution.

Subsequently, a test piece was manufactured in a similar manner to Example 1 except that a damping resin layer was formed to have a thickness of 100 μm by use of the application material prepared in the present example.

### Example 9

First, a test piece was manufactured in a similar manner to Example 8 except that a damping resin layer was formed to have a thickness of 200 μm.

Subsequently, a damping insulator including the damping resin layer on a bottom surface of a tolerance ring was manufactured in a similar manner to Example 7, except that an application material similar to the application material in Example 8 was used. Then, the damping insulator was mounted in a fuel injection device. Thus, a mounted damping insulator was manufactured.

Subsequently, a damping insulator including the damping resin layer on an inner-peripheral-side tapered surface of a tolerance ring was manufactured in a similar manner to Example 7, except that an application material similar to the application material in Example 8 was used. Then, the damping insulator was mounted in a fuel injection device. Thus, a mounted damping insulator was manufactured.

Subsequently, a damping insulator including the damping resin layer on a bottom surface and an inner-peripheral-side tapered surface of a tolerance ring was manufactured in a similar manner to Example 7, except that an application material similar to the application material in Example 8 was used. Then, the damping insulator was mounted in a fuel injection device. Thus, a mounted damping insulator was manufactured.

### Example 10

An application material was prepared in a similar manner to Example 1 first, except that microcapsules were prepared as damping filler, and a predetermined amount of the microcapsules was added to a solution.

Subsequently, a test piece was manufactured in a similar manner to Example 1 except that a damping resin layer was formed to have a thickness of 100 μm by use of the application material prepared in the present example.

### Example 11

First, a test piece was manufactured in a similar manner to Example 10 except that a damping resin layer was formed to have a thickness of 200 μm.

Subsequently, a damping insulator including the damping resin layer on a bottom surface of a tolerance ring was manufactured in a similar manner to Example 7, except that an application material similar to the application material in Example 10 was used. Then, the damping insulator was mounted in a fuel injection device. Thus, a mounted damping insulator was manufactured.

Subsequently, a damping insulator including the damping resin layer on an inner-peripheral-side tapered surface of a tolerance ring was manufactured in a similar manner to Example 7, except that an application material similar to the application material in Example 10 was used. Then, the damping insulator was mounted in a fuel injection device. Thus, a mounted damping insulator was manufactured.

Subsequently, a damping insulator including the damping resin layer on a bottom surface and an inner-peripheral-side tapered surface of a tolerance ring was manufactured in a similar manner to Example 7, except that an application material similar to the application material in Example 10 was used. Then, the damping insulator was mounted in a fuel injection device. Thus, a mounted damping insulator was manufactured.

### Comparative Example 1

First, a block-shaped base material similar to the base material in Example 1 was prepared and was used as a test piece without forming a damping resin layer.

Subsequently, an annular tolerance ring similar to the tolerance ring in Example 7 was prepared and was used as a damping insulator without forming a damping resin layer. Subsequently, a cylinder head, a fuel injection valve, and a delivery pipe similar to those used in Example 7 were prepared. Subsequently, the damping insulator and the fuel injection valve were attached to the cylinder head, and the delivery pipe was further attached thereto. After that, they were fastened by bolts. At this time, the damping insulator was placed between a shoulder of an insertion hole of the cylinder head and a stepped portion of the fuel injection valve so that the damping insulator abutted with the shoulder by a bottom surface of the tolerance ring, and the dumping insulator abutted with an outer-peripheral-side tapered surface of the fuel injection valve by an inner-peripheral-side tapered surface of the tolerance ring. Hereby, the damping insulator was mounted in a fuel injection device, and thus, a mounted damping insulator was manufactured.

Evaluation on Influence of Thickness of Damping Resin Layer on NV Performance in Falling Ball Test

The test pieces obtained in Examples 1 to 11 and Comparative Example 1 were subjected to a falling ball test, and the influence of the thickness of a damping resin layer on NV performance was evaluated. FIG. 3 is a sectional view schematically illustrating a falling ball testing machine.

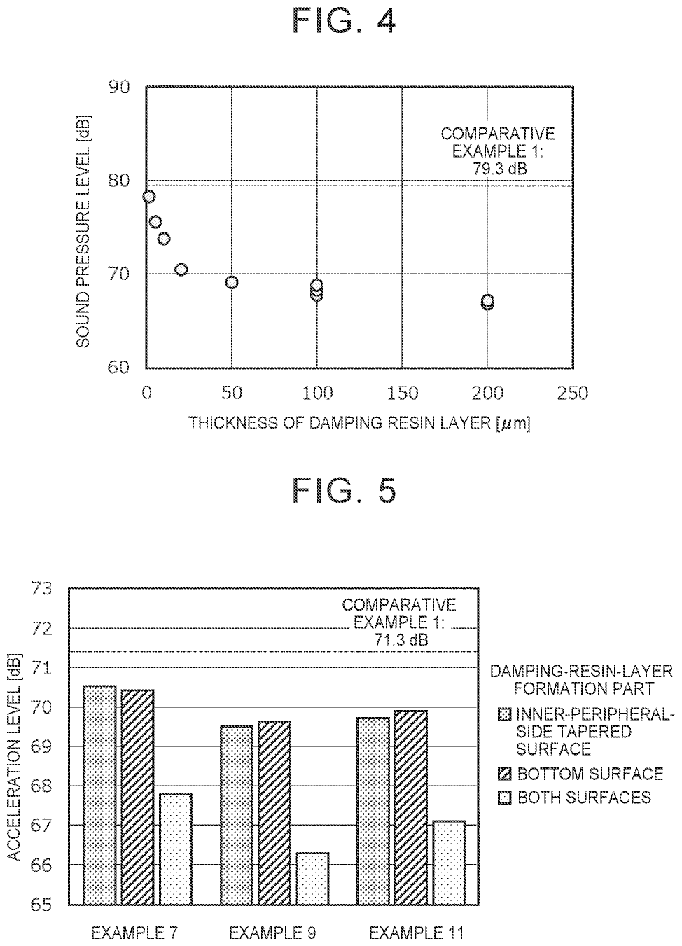

In the falling ball test, a test piece was set on a steel sheet on an acceleration pickup provided in an upper part of a base of the falling ball testing machine, as illustrated in FIG. 3. When the test pieces of Examples 1 to 11 were set, their damping resin layers were placed to abut with the steel sheet. The reason is as follows. That is, the purpose of the falling ball test is to measure how much noise is restrained at the time when impact is given to a damping resin layer placed in a gap between a component and a component. In the falling ball testing machine, a steel ball made of SUJ2 and with ϕ of 6.3 mm is held right above a test piece by an electromagnet. In the falling ball test, the steel ball was set at a height of 500 mm (a distance from the top face of the test piece) before the steel ball was dropped, and then, the steel ball was dropped by turning off the magnetic force of the falling ball testing machine, so that the steel ball hit the test piece. Sound generated at the time when the steel ball hit the test piece was collected by a microphone provided right above the test piece, so that the sound pressure level of an overall value in a bandwidth from a frequency of 20 Hz to a frequency of 10 kHz was measured. Measurement results are shown in Table 1. FIG. 4 is a graph illustrating the sound pressure level of sound generated at the time of hitting of the steel ball in relation to the thickness of the damping resin layer in each of the test pieces in Examples 1 to 11 and Comparative Example 1.

As illustrated in Table 1 and FIG. 4, as the film thickness of the damping resin layer increases, the sound pressure level decreases. Accordingly, it is considered that the NV performance improves as the film thickness of the damping resin layer increases. When the test piece made of only the base material in Comparative Example 1 is compared with the test pieces in Examples 1 to 7 with the damping resin layers of the same composition, test pieces in which the thickness of the damping resin layer is thinner than 10 μm exhibit a reduction effect to reduce the sound pressure level as compared with the test piece made of only the base material. However, the reduction effect is not large. In the meantime, test pieces in which the thickness of the damping resin layer is 10 μm or more exhibit a reduction effect to reduce the sound pressure level by 5 dB or more as compared with the test piece made of only the base material. Accordingly, it is considered that the thickness of the damping resin layer is preferably 10 μm or more, more preferably 20 μm or more, and particularly preferably 50 μm or more. Further, as illustrated in Table 1 and FIG. 4, even in a case where the type of the damping filler of the damping resin layer is changed, a similar tendency is found.

Evaluation on NV Performance of Mounted Damping Insulator

The NV performance of each of the mounted damping insulators provided in Examples 7, 9, 11 and Comparative Example 1 was evaluated. Note that, in terms of the evaluation on the NV performance of each of the mounted damping insulators provided in Examples 7, 9, 11, the NV performance was evaluated on each of three types of damping insulators, i.e., a damping insulator in which the damping-resin-layer formation part is the inner-peripheral-side tapered surface, a damping insulator in which the damping-resin-layer formation part is the bottom surface, and a damping insulator in which the damping-resin-layer formation part is the inner-peripheral-side tapered surface and the bottom surface.

More specifically, the fuel injection valve of the fuel injection device was connected to a waveform generator, and an acceleration pickup was attached to the cylinder head of the fuel injection device. After that, a pulse wave with a frequency of 10 Hz was input from the waveform generator into the fuel injection valve at a uniform duty ratio, so that a needle inside the fuel injection valve was vibrated. Then, the acceleration level of an overall value of the vibration in a bandwidth from a frequency of 20 Hz to a frequency of 20 kHz that was transmitted to the cylinder head was measured by the acceleration pickup. Measurement results are shown in Table 1. FIG. 5 is a graph illustrating acceleration levels of vibration transmitted to the cylinder head in terms of the three types of mounted damping insulators with different damping-resin-layer formation parts in each of Examples 7, 9, 11. Note that, in the graph of FIG. 5, the acceleration level of vibration transmitted to the cylinder head from the mounted damping insulator obtained in Comparative Example 1 is indicated by a broken line.

As illustrated in Table 1 and FIG. 5, the three types of mounted damping insulators with different damping-resin-layer formation parts in each of Examples 7, 9, 11 achieve large reduction effects to reduce the acceleration level regardless of the damping-resin-layer formation parts, in comparison with the mounted damping insulator obtained in Comparative Example 1. In a case where the damping resin layer is formed on the bottom surface or the inner-peripheral-side tapered surface of the tolerance ring or on both of them, it is considered that the transmission of vibration generated in the fuel injection valve to the cylinder head is blocked by the damping resin layer, so that the acceleration level is reduced.

TABLE 1

| | | | | | NV PERFORMANCE OF MOUNTED DAMPING | | |
|---|---|---|---|---|---|---|---|
| | | | | | INSULATOR | | |
| | | | | | DAMPING-RESIN-LAYER FORMATION PART | | |
| | | | | | INNER- | | |
| | | | | FALLING | PERIPHERAL- | | |
| | | | | BALL | SIDE | | |
| | | | | TEST | TAPERED | BOTTOM | BOTH |
| | DAMPING RESIN LAYER | | | SOUND | SURFACE | SURFACE | SURFACES |
| | HEAT- | | | PRESSURE | ACCELERATION | ACCELERATION | ACCELERATION |
| | RESISTANT | DAMPING | THICKNESS | LEVEL | LEVEL | LEVEL | LEVEL |
| | RESIN | FILLER | [μm] | [dB] | [dB] | [dB] | [dB] |
| COMPARATIVE | NO DAMPING RESIN LAYER | | | 79.3 | 71.3 | 71.3 | 71.3 |
| EXAMPLE 1 | | | | | | | |
| EXAMPLE 1 | POLY- | THERMO- | 1 | 78.3 | — | — | — |
| EXAMPLE 2 | AMIDEIMIDE | PLASTIC | 5 | 75.6 | — | — | — |
| EXAMPLE 3 | | ELASTOMER | 10 | 73.8 | — | — | — |
| EXAMPLE 4 | | | 20 | 70.5 | — | — | — |
| EXAMPLE 5 | | | 50 | 69.1 | — | — | — |
| EXAMPLE 6 | | | 100 | 67.8 | — | — | — |
| EXAMPLE 7 | | | 200 | 66.9 | 70.5 | 70.4 | 67.8 |
| EXAMPLE 8 | | URETHANE | 100 | 68.3 | — | — | — |
| EXAMPLE 9 | | RESIN | 200 | 66.8 | 69.5 | 69.6 | 66.3 |
| EXAMPLE 10 | | MICRO- | 100 | 68.8 | — | — | — |
| EXAMPLE 11 | | CAPSULES | 200 | 67.2 | 69.7 | 69.9 | 67.1 |

Details of the embodiments of the damping insulator according to the present disclosure have been described above. The present disclosure is not limited to the embodiments, and various design changes can be made without departing from the spirit of the present disclosure described in Claims.

What is claimed is:

1. A damping insulator for a fuel injection device, the damping insulator being for restraining vibration to be transmitted between a fuel injection valve and a cylinder head, wherein:
the fuel injection valve is attached to the cylinder head in a state where the fuel injection valve is passed through an insertion hole provided in the cylinder head;
a shoulder is provided by expanding an inlet portion of the insertion hole in an annular shape;
the fuel injection valve includes a stepped portion reduced in diameter in a tapered shape such that an outer-peripheral-side tapered surface is formed to face the shoulder;
the damping insulator is configured to restrain the vibration by being provided between the stepped portion and the shoulder;
the damping insulator includes
an annular tolerance ring having a bottom surface facing the shoulder and an inner-peripheral-side tapered surface facing the outer-peripheral-side tapered surface, and
a damping resin layer provided on the bottom surface or the inner-peripheral-side tapered surface of the tolerance ring; and
the damping resin layer contains heat-resistant resin and damping filler configured to convert vibrational energy into thermal energy.

2. The damping insulator according to claim 1, wherein the damping resin layer is provided on the bottom surface of the tolerance ring.

3. The damping insulator according to claim 1, wherein the damping resin layer has a thickness of 10 μm or more.
